(19) United States
(12) Patent Application Publication
(10) Pub. No.: US 2006/0174230 A1
(43) Pub. Date: Aug. 3, 2006

(54) Methods for hosting general purpose computer languages on speical purpose systems

(75) Inventors: Gary L. Drayton, King of Prussia, PA (US); Leon B. Lambert, St. Charles, IL (US); Jethro F. Steinman, Havertown, PA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/048,012

(22) Filed: Jan. 31, 2005

(51) Int. Cl. G06F 9/45

(52) U.S. Cl. 717/136

(57) ABSTRACT

The present invention relates to the field of software development for special purpose computers or digital system, and in particular, provides systems and methods for generating executable code for a target special purpose system from a general purpose computer language not specifically directed to the special purpose system. In a preferred embodiment, first, general purpose language source code is compiled to an intermediate language, such as Java byte-code; second, the intermediate language is translated to a special purpose language implemented for the special purpose system, often the C language or a variant; and third, the translated special purpose language is compiled into executable code for the special purpose system. Additional embodiments include systems performing these software development methods and related program products and/or computer-readable media.

### 1. FIELD OF THE INVENTION

The present invention relates to the field of software development for special purpose computer and digital systems, and in particular, provides systems and methods for generating executable code for a target special purpose system from a general purpose computer language not specifically directed to that special purpose system.

### 2. BACKGROUND OF THE INVENTION

A considerable number of different computer languages have been proposed and developed, which have been based on a wide variety of design principles and have been implemented on hardware with a wide variety of capabilities. A more recently recognized design principle, platform independence, is today a further important consideration in the design of many languages. (Platform generally means a particular operating system (“OS”)/processor combination, such as Microsoft Windows operating systems on Intel x86 processors.) However, many of the existing languages, especially older languages, were not designed against a platform independent model and were not implemented in a platform independent manner.

The Java™ language illustrates recent techniques for implementing platform independence. Java implementations are structured into a compile-time component and a separate run-time component. See, e.g., Joy et al., 2000 2^{nd} ed., Java Language Specification, Addison-Wesley Professional; and Lindholm et al., 1999 2^{nd} ed., The Java Virtual Machine Specification, Addison-Wesley Professional. The compile time component is platform independent; it translates Java source code into an intermediate language called Java “byte code” (an example of an intermediate language (“IL”)) for execution by a Java virtual machine. The run-time component is platform specific; it executes byte-code on a specific platform and is usually different for different target OS and/or hardware platforms. Important approaches to the Java run-time component implementation are: interpretation of the byte code; or just-in-time compilation of byte code immediately prior and during execution; or traditional ahead-of-time compilation of byte-code in a step preceding execution.

Structuring a language into a platform-independent compile-time component and a platform-dependent run-time component that interface through an intermediate language has been found to an effective technique for realizing platform independence among general purpose computer systems, such ordinary PCs, workstations, and servers. However, many computer and digital systems of interest are not general purpose and present requirements considerably different from general purpose systems. For example, modern products and devices are increasingly being controlled with programmable microprocessors or micro-controllers that operate special purpose sensing or control hardware or use memory with specific behavior. Computer languages designed and implemented for independence among general purpose platforms can often be less suitable for use with such special purpose computer and digital systems. Even through a particular general purpose language may be desirable, having an attractive and widely known syntax, it can be difficult or impossible to use for special purpose systems.

In the case of Java, efforts have been made to expand the scope of platforms which can host the language by providing, at least, run-time components. But it is not a foregone conclusion that Java can run on every special purpose computer or digital system with suitable efficiency, behavior, and so forth. Questions include: is there a run-time component of a common off-the-shelf compiler (“COTS”) available in the market that meets hardware requirements, that can run within available memory or processing resources, and the like? If there is no suitable commercially available COTS run-time, can a custom run-time component be designed and coded using only available organizational skills and resources? Will such a custom run-time when complete even meet the requirements of the target platform?

Further, Java-like implementations of other widely-used language systems are becoming available, for example the Microsoft NET languages (VB.NET, C# and others). However, their Microsoft intermediate language (known as MSIL) is currently available on far fewer platforms than Java. Additionally, intermediate languages currently being standardized, for example, Standard ECMA-335 Common Language Infrastructure (CLI), may be available on no more that one or two reference platforms.

These and other issues indicate that the common model for platform independence, even when it exists, may not be appropriate to meet the needs of a special purpose computer and digital systems. Therefore, there remains a need in the art for technically adequate and economically suitable methods for executing and/or hosting a variety of computer languages on a variety of computer platforms.

A number of references are cited herein, the entire disclosures of which are incorporated herein, in their entirety, by reference for all purposes. Further, none of these references, regardless of how characterized above, is admitted as prior to the invention of the subject matter claimed herein.

### 3. SUMMARY OF THE INVENTION

The objects of this invention include meeting the needs in the prior art identified above by providing systems and methods for programming special purpose digital systems using general purpose languages typically designed and implemented only for general purpose computer systems.

Briefly, this invention's methods (translation methods “TM”) translate source code written in a more general language typically designed for more general purpose computing on more general purpose computer systems (referred to herein as a front end language (“FEL”)) into code executable on a special purpose computer or digital system (referred to herein as a back end system (“BES”)). These TMs are advantageously performed by this invention's systems (translation systems (“TS”)). For example, the FEL may be designed to program general purpose computer systems such as standard PCs, workstations, or servers, while the BES may be a micro-controller, microcomputer, microprocessor, or similar programmable device embedded in a larger system, machine, or product. Further, several such programmable devices may be linked in order to control a complex, multi-component device, e.g., a car, multiple devices cooperating to perform an industrial process, an airplane, and the like. Such micro-controllers, microcomputers, and microprocessors may implement sequential instruction processing, digital signal processing instructions, parallel instruction processing, and the like.

An FEL suitable for this invention will preferably have a compile-time component that produces an intermediate language capable of specifying virtually all possible computations (known as “universal”), and will preferably be available as one or more commercial off-the-shelf compilers (“COTS”) available from multiple vendors. A BES suitable for this invention will itself preferably have at least one computer language (referred to herein as a back end language (“BEL”)) with a syntax and semantics adapted to the BES. In almost all cases, the BES run time component will be a standard ahead-of-time compiler that preferably generates code directly executable by the BES that is optimized to efficiently and adequately exploit the BES. In many BES applications, code optimization and small executable size are important design considerations. The BEL is also preferably implemented by at least one COTS compiler, which will typically be available from vendors perhaps including the programmable device manufacturer.

Preferred TM embodiments produce code executable on the target BES from source code written in a desirable FEL in the following manner. First, the FEL source code is processed by the FEL compile-time component to produce equivalent intermediate language output code. Next, the equivalent intermediate language output code is translated into equivalent source code suitable for processing by the BEL compiler. Finally, the equivalent BEL source code is processed by the BEL compiler to produce output code directly executable on the BES (perhaps with one or more run-time support routines). The IL-BEL translator may be commercially available or in the public domain, or otherwise available. Otherwise, this translator is designed and coded for this invention using known techniques of compiler writing and code generation.

In other words, a preferred FEL COTS implements Java-like platform independence It outputs code that, instead of being directly executable on a particular system and thus entirely platform-specific, is an intermediate language having a substantially platform-independent specification that only minimally limits a suitable run-time platform. The translation step then translates this intermediate language into BEL source, a step often referred to in the art as “reverse-translation” or “reverse-compilation”. Such an intermediate language is specifically referred to herein as a low level intermediate language (“LLIL”). LLIL use simplifies translator construction, and further, if multiple FELs produce the same LLIL, a single translator can produce BES code from the multiple FELs. Although within the scope of certain embodiments, it is less preferred to translate platform specific assembly-type languages; and even less preferred to translate directly-executable machine language.

The LLIL-BEL translator, in some embodiments, preferably reproduces in translated BEL source code the computational content of its input LLIL code. In other words, ignoring hardware limitations, translated BEL source is computationally equivalent to LLIL input, and it may be then presumed that the executable code produced by the BEL is also computationally equivalent to the original FEL source. In other embodiments, however, the translator is preferably specialized. For example, only a subset of FEL language features may be appropriate for implementation on the target BES. If so, the translator can enforce such subset restrictions, and optionally flag those constructs that are not acceptable.

For another example, modern FEL languages such as Java require run-time memory non-determinism, which is often not appropriate for a BES. The translator can control or eliminate memory non-determinism. For an additional example, some special purpose computer or digital systems must run continuously for up to years. However, most COTS compilers and other commercial tools change from time-to-time at least to accommodate marketing requirements, and such changes can introduce great risk in maintaining long-running BES software. However, such changes can often be absorbed by the translator so that the target BES software is insulated from market developments.

This invention can be particularly advantageous technically for target computer and digital systems which have one or more of the following characteristics. The target systems are implemented with custom hardware, or with microprocessor or micro-controllers which are not supported by the general purpose languages of choice, or have hardware characteristics not easily accommodated by general purpose languages. The target systems have real time requirements, or determinism requirements, or robustness requirements.

This invention can also be particularly advantageous for a development organization. Developing software for special purpose embedded digital systems is often more labor intensive and expensive than developing similar software for general purpose computer systems. This invention can limit this cost by allowing major portions of embedded system software development to be moved out of the realm of embedded systems and into the realm of general purpose computers. This invention can allow embedded systems to be programmed by those without professional computer science experience, or in more than one language. For example, system implementers may not have the experience needed to create a sufficient language run-time. Finally, although this invention can require development and maintenance of a translator (if not otherwise available), this can be less expensive and burdensome than the alternative. Without this invention, an organization may need to re-target an entire general purpose FEL system to a specific BES. Skills with optimizing compilers is quit a rare specialty.

Many embodiments of this invention will be appreciated from the following detailed descriptions and attached figures. Certain of the described embodiments are recited in appended claims. This is without disclaimer or prejudice to other embodiments and combinations not presently recited.

### 4. BRIEF DESCRIPTION OF THE DRAWINGS

The present invention may be understood more fully by reference to the following detailed description of preferred embodiments, illustrative examples of specific embodiments, and the appended figures in which:

FIG. 1 illustrates a general preferred embodiment;

FIG. 2 illustrates a more specific preferred embodiment; and

FIG. 3 illustrates an exemplary system.

### 5. DETAILED DESCRIPTION OF THE PREFERRED EMBODIMENTS

The present subsection describes preferred embodiments of this invention's translation methods (“TM”) and translation systems (“TS”). Here, and throughout the application, headings are used for clarity and convenience only. The term “translating” is used in certain contexts herein and in the claims to mean generically the steps of transforming a computer program from its representation in one programming language into an equivalent representation in another programming language

Translation Methods

The present invention's TMs and TSs combine new and existing software tools in new combinations to make possible the production of executable code for special purpose computer and digital systems (“BES”) from source code designed and written in general purpose languages (“FEL”) directed to general purpose computer systems. Among the existing software tools are one or more FELs, commercially-available (“COTS”) compilers for the FELs, and preferably, associated software tools such as development environments with debuggers, testers, and the like. FELs of interest will generally have certain language designs and features attractive for software development, but will also have other designs and features that are unattractive for execution on the target BES. For example, their run-time components may require hardware features not available in the target BES, or they may simply not be implemented for the BES.

Preferable FELs have a platform independent architecture with separate compile-time components and run-time components that interface through a low-level intermediate language (“LLIL”). The compile-time component translates a source program into LLIL; and then the run-time component translates the LLIL into executable code (or interprets the LLIL). Preferred LLILs require only generic hardware execution models (such as a stack machine model) that are substantially independent of particular processor architectures and instruction sets. More machine specific LLILs, such as various assembly languages or even directly-executable code, are less preferred.

Another already-existing tool is at least one special purpose language (“BEL”) targeted and designed for the intended BESs. A BEL preferably inputs source code with a known syntax, such as the C language or its variants, and outputs code directly executable by the BES that is optimized to exploit BES processing capabilities. However, the BEL will often have other features that are unattractive for program development. For example, supported programming structures may be limited; a development environment and supporting tools may be unavailable, and the like. The BEL may be supplied by the manufacturer of the programmable device used in the target BES and will have a compiler that executes on a general purpose computer system but produces code only for the manufacturer's device.

A tool specific to the present invention is a translator from the LLIL into BEL input source code. In some embodiments such a translator, which is often otherwise known as a “reverse compiler”, may be commercially available or in the public domain. In other embodiment, such a translator will need to be specifically designed and coded. Translator design requires only basic and well-known principles of compiler construction. See generally, e.g., Aho et al., 1986, Compilers, Addison Wesley; Muchnick, 1997, Advanced Compiler Design and Implementation, Morgan Kaufmann. First, the LLIL input, which generally has a simplified syntax, is parsed into an intermediate, usually tree-like, program representation. The parsing component may be constructed using one of the parser generators well known in the art. Second, the intermediate representation is traversed to generate output code conforming to the BEL syntax. This code generation component can be simplified when only a subset of the full BEL will suffice for code generation. Further optimization of generated code need not be extensive when the BEL adopted is implemented by an optimizing compiler.

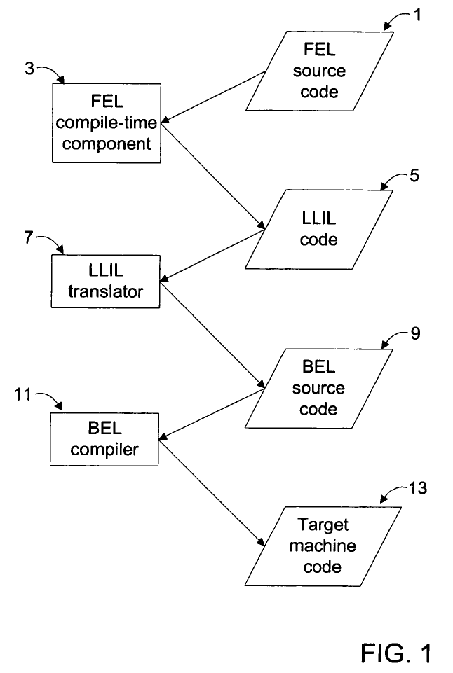

FIG. 1 illustrates how these tools are combined to enable a programmer to develop optimized code targeted to the intended BES from a desirable FEL language and development environment. In the illustrated preferred embodiment, FEL source code 1, written for execution on the target BES, is processed into target machine code 13 by the following steps. First, source 1 is processed by the FEL compile-time component 3 to produce LLIL source code 5. Second, LLIL source code 5 is processed by LLIL translator 7 to produce BEL source code 9. Finally, BEL source code 9 is processed by BEL compiler 1 1 to product target machine code 13.

This invention also includes preferred embodiments having particular choices for the FEL, LLIL, and BEL. With respect to preferred FEL choices, any FEL chosen must have compile-time components (compilers) outputting an LLIL for which a translator is available or can be developed. Virtually any language may be a useful FEL, since a translator could in principle be developed for any assembly language, or even any machine language, it might output. For example, a translator from assembly language to C could be developed. Though if an assembly language were chosen as the FEL, it would preferably handle machine specific features (such as machine control instructions) which may not be translatable gracefully by flagging an error or exception. However, FELs are more preferred if they can be compiled into at LLILs which are more modern or are at least partially standardized. For example, Pascal is an older language suitable for certain applications that is often implemented by compilers outputting p-code, a known LLIL. It could serve as a suitable FEL.

Java is an example of a more preferred FEL that provides object-oriented program structures for which programming skills are known, and is implemented by compilers available from several vendors. Although not formally standardized, the Java intermediate language, Java byte-code, is known and documented in texts. Further, translators from Java byte-code to C source code are known. See, e.g., Muller et al., 1997, Harissa: a Flexible and Efficient Java Environment Mixing Byte code and Compiled Code, Proc. 3^{rd} USENIX Conf. on Object-Oriented Technologies and Systems, Portland, Oreg., June 1997; and Proebsting et al., 1997, Toba: Java for Applications A Way Ahead of Time (WAT) Compiler, Proc. 3^{rd} USENIX Conf. on Object-Oriented Technologies and Systems, Portland, Oreg., June 1997. LLIL translator implementation is simplified if it can be based on existing tools.

Further examples of more preferred FELs are the newer languages now available (or expected shortly) that output more modern and at least partially standardized LLILs. For example, the Microsoft .NET languages, including C++ with managed extensions, C#, Visual Basic, and JScript, output a Microsoft intermediate language (“MSIL”).

With respect to LLILs, “p-code” generated by Pascal and related languages is preferred as it was originally designed to support a level of machine independence. Java byte-code has already been described as an example of a preferred LLIL. However, more preferred LLILs are those that support or can support a variety of FELs and are at least partially standardized. Correspondingly, those FELs that can be compiled into such LLILs are also more preferred. Standard ECMA-335 is an example of a more preferred LLIL that defines an intermediate language implementing common data types, extensible metadata, object classes, more sophisticated execution models, and the like. See, e.g., Standard ECMA-335 Common Language Infrastructure (CLI), 2^{nd} ed. 2002, ECMA International, Geneva (formerly known as the European Computer Manufacturers Association). MSIL is also preferred, because, first, it is the target intermediate language for a variety of widely used FELs, and second, overlaps considerably with ECMA-335 and can be considered as including a subset of this standard. Although proprietary in its broad scope, MSIL may be considered at least partially standardized because Microsoft has placed large portions in the public domain that have a considerable overlap with and standardization in standard ECMA-335.

In certain embodiments, this invention, in particular the LLIL-BEL translator, advantageously implements only a portion of a conventional or standardized LLIL (referred to herein as an “LLIL subset”), or advantageously implements a portion or all of such an LLIL along with additional facilities (referred to herein as an “LLIL superset”). For example, MSIL can be considered as a standard ECMA-335 superset. Certain LLILs promote such partial implementations by defining levels or profiles, where a level or profile defines a group of facilities and features of the whole LLIL (subsets) that must be implemented in this level or profile. An implementation can confirm to such an LLIL by implementing only the facilities and features required in a particular level or profile. For example, standard ECMA-335 defines two profiles, a kernel profile and a compact profile, as well as additional libraries that can be implemented as needed although they are not part of a profile (supersets). See Standard ECMA-335 Common Language Infrastructure (CLI), Partition IV. For such LLILs, the LLIL-BEL translation preferably implements one or more such levels or profiles.

With respect to BELs, the C language is preferred at least because many device manufacturers provide compilers for standard or modified C for the programmable devices; because basic C programming skills are widely known; and so forth. Also, C optimization technology is also well known and widely available.

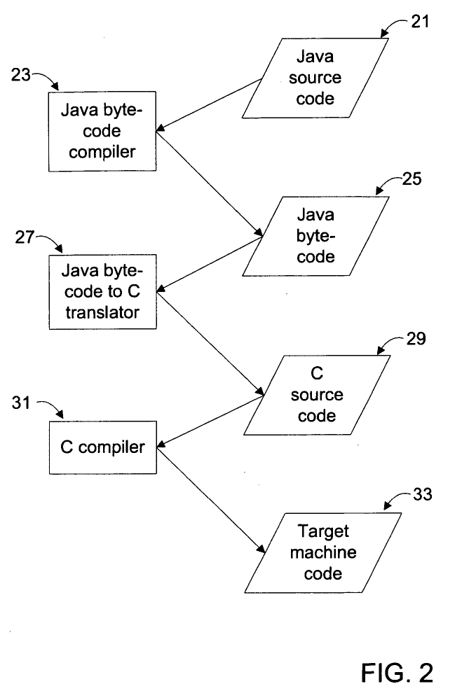

One particular, preferred embodiment using Java-C is illustrated in FIG. 2. First, C source code 21 is processed by Java byte-code compiler 23 to produce byte-code intermediate language 25. Second, byte-code intermediate language 25 is processed by Java-byte-code-to-C translator 27 to produce C source code 29. Finally, C source code 29 is processed by C compiler 31 to product target machine code 33. Other choices for the BEL, FEL, and LLIL result in other preferred particular embodiments that are readily constructed to meet particular applications. With respect to BELs, in addition to C, C++ is a suitable choice. C++ allows additional translator flexibility. Since C++ usually includes C as a subset, a translator to either language will properly cooperate with this BEL.

Turning now to the LLIL-BEL translator, generally this component should faithfully render the computational content of LLIL input into BEL source output. However, less than complete rendering may be advantageous in certain embodiments. When the input LLIL is more recent and more sophisticated, it may be advantageous not to translate features that might be inappropriate or resource-intensive for a target BES. In fact, certain features may require hardware capabilities not available on the target. Preferably, such features not translated should be flagged to the user as exceptions or errors.

Further, a translator may advantageously implement checks and limits. For example, the target digital system may have limited hardware resources requiring strict resource control, or may have specialized hardware resources requiring specialized programming structures. A preferred translator may advantageously estimate resource usage or evaluate program structure and then flag those portions of an LLIL input that are resource intensive. Or it may add (upon request) resource monitoring code during program development. Also, the target digital system may have robustness requirements such as prevention of excessively prolonged (or infinite) execution loops. A translator may advantageously check at translate time or monitor at execution time for such defects. Additionally, a target digital system may have requirements for uninterrupted operation even if changes are made elsewhere in an overall system. For example, it may be desirable for the target system to operate with a program generated from a previous FEL version even after introduction of a new FEL version which produces a modified LLIL. A translator may allow modification to an LLIL without disturbing existing, operating BEL programs and without requiring new forms of support from the BES. However, these desirable features need not necessarily be implemented by the translator, because in some embodiments, the BEL compiler will provide some or all of these checks and limits.

In particular, these features advantageously aid in handling software upgrades and changes made to the FEL, to the FEL compiler/translator and/or its LLIL code generator, or to the LLIL itself should it be partially proprietary. Such largely internal changes can affect the operation on the target digital system of existing program that were written for the superseded versions. In this case, compensating changes can be made in the LLIL-BEL translator in order to restore and correct changes in target system operation. In other words, owners of the FEL source code can be protected from having to reprogram in the event of vendor changes and upgrades that are largely out of their control. Corresponding changes and updates can be made to the LLIL-BEL translator, a component which is often under the FEL code owner's control. Alternatively, this translator may be under the control of the owner or manufacturer of the target digital system, which can then provide this protection to their customers.

Optionally, the present invention also includes ease-of-use features. Basic ease-of-use features will automate generation of executable code for the target BES from FEL source by coordinating the execution of the various software components, such as the FEL component, the translator, the BEL component, and the like. This coordination may be as simple as controls written in a scripting language, a system control language, or the like. Preferably, this coordination is implemented by a monitoring program that additionally presents a consistent graphical user interface (GUI) to the FEL, translator, and BEL tools. This GUI will hide to a reasonable extent the idiosyncrasies or peculiarities of each separate tool from the user.

It is also preferable for a monitor program or the like to provide a programming environment by including tools supporting program development. For example, code tracking tools can relate translated BEL source statements, BES executable code segments, and and/or LLIL code segments to their parent FEL source statements, and vice versa. BES emulator tools with single-stepping, breakpoints, and the like, can check the correctness of BES executables and help debug errors. If the emulator also provides execution performance monitoring, program hot-spots can be caught and corrected early in development. A monitor program may advantageously include other development tools known in the art.

Translation Systems

Embodiments of the translation methods of the present invention are implemented as program products including, at least, the LLIL-BEL translator optionally along with ease-of-use features such as a monitor program with development tools features These programs are preferably written in a standard general purpose language, for example, Java, C, or C++, and compiled into the interpretable or executable code included with the program products. Program products with FEL and BEL language systems may be separately acquired from their preferred vendors, or alternately, these language systems may be integrated with the executable code of the program products of this invention. These program products may be distributed as is known in the art, for example, on computer-readable media such as CD-ROMs or the like. A computer system having these program products loaded in memory (a further embodiment of this invention) then performs the methods of this invention.

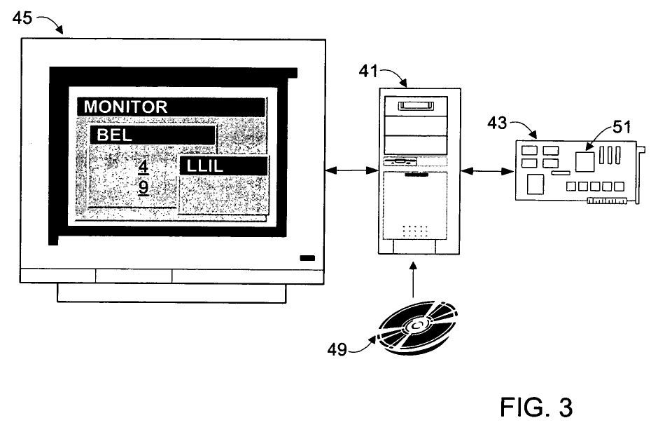

These program products are constructed so that they may be executed by at least one common variety of general purpose computer system and preferably by two or more (for example, Windows and Linux systems). In nearly all cases, the target special purpose computer or digital system will not be suited for program development. Accordingly, FIG. 3 illustrates general purpose computer system 41 (such as a PC, workstation, or server) having the program products of this invention loaded into memory from computer readable media 49. General purpose computer 41 generates executable BES code by performing FEL processing, LLIL-BEL translation, and BEL processing, all optionally controlled by ease-of-use components.

Populated printed circuit board (PCB) 43 illustrates an exemplary target BES. This exemplary BES system is built around, for example, micro-controller 51, which is the programmable component that executes BEL output code. PCB 43 may be intended for use as a computer sub-assembly, as a machine controller, as an industrial plant sensor, as a dedicated personal device, and the like. Executable code generated by computer 41 may be written into, for example, flash memory components that are part of PCB 43. Alternately, PCB 43 and/or micro-controller 51 may be linked to test and debug equipment that monitors and/or controls PCB hardware. Preferably, this equipment interfaces to computer 41 which hosts software to monitor and control the PCB that may advantageously be integrated with this invention's code development environment. This latter program-product configuration is referred to herein as a BES development system.

Display 45 presents an exemplary embodiment of a monitor program GUI. Here, GUI window labeled MONITOR is the overall interface to the monitor program/development environment. Since, computer 41 is currently performing, for example, an LLIL-BEL translation, the monitor program presents a sub-window labeled LLIL that interfaces to the translator and further sub-window labeled BEL that interfaces to the BEL. If the current step was FEL or BEL processing, the monitor would open appropriate different sub-windows. If software or hardware test and debug were being performed, the monitor would open appropriate further different sub-windows

Finally, it is intended that the present invention also have other embodiment including various sub-combinations of the above-described systems, program products, and computer readable media. Such other embodiment include computer-readable media 49 with only a translator; or with only a translator and ease-of-use features such as a monitor program; or with only a translator, a monitor program, and components for software and/or hardware test and debug, and the like. Further embodiments include computer system 41 with software from these embodiments of computer-readable medium 49 loaded in memory. As already explained, any of these embodiments may advantageously include an FEL and/or a BEL language system, even though these are preferably supplied by other commercial entities.

Additional other embodiments include kits including a target BES, such as PCB 43, along with one of the embodiments of computer-readable media 49. Such a kit might be advantageously supplied by a BES manufacturer to customers for their development and test activities.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

A number of references are cited herein, the entire disclosures of which are incorporated herein, in their entirety, by reference for all purposes. Further, none of these references, regardless of how characterized above, is admitted as prior to the invention of the subject matter claimed herein.

What is claimed is:

1. A method for generating code executable by a target programmable device from code conforming to a first computer language, the method comprising:
translating said code conforming to said first computer language into intermediate language code;
translating said intermediate-language code into code conforming to a second computer language; and
translating said code conforming to said second computer language into said code executable by the target programmable device.

2. The method of claim 1 wherein said intermediate language does not require features that are unique to said target programmable device.

3. The method of claim 1 wherein said intermediate language requires features that are unique to said target programmable device.

4. The method of claim 3 wherein said intermediate language conforms to a standard proposed and/or approved by a standards body.

5. The method of claim 4 wherein said intermediate language conforms to a subset of a standard proposed and/or approved by a standards body.

6. The method of claim 5 wherein said intermediate language is not limited to said subset.

7. The method of claim 1 wherein said intermediate language can be translated for, and/or interpreted by, at least two computer systems having different processors and/or operating systems.

8. The method of claim 1 wherein said first computer language is a general purpose computer language used for programming general purpose computer systems.

9. The method of claim 1 wherein said first computer language is selected from the group consisting of C++, a version of C, an assembly language, C#, Visual Basic, and Jscript.

10. The method of claim 1 wherein said intermediate language is selected from the group consisting of Java byte-code, p-code, a versions of Standard ECMA-335, and an assembly language.

11. The method of claim 1 wherein said second computer language is selected from the group consisting of C++, a version of C, and an assembly language.

12. The method of claim 1 where said step of translating said intermediate-language code renders the computational content of said code conforming to said intermediate language into the computational content of said code conforming to said second computer language.

13. The method of claim 1 where said step of translating said intermediate-language code renders the computational content of said intermediate language code into said code conforming to said second computer language except for intermediate language code that is unsupported by the target digital system.

14. The method of claim 1 where said step of translating said intermediate-language code renders the computational content of said intermediate language code into said code conforming to said second computer language except for intermediate language code that is resource-intensive when executed by the target digital system.

15. The method of claim 1 where said step of translating said intermediate-language code further checks code being translated for execution time errors.

16. The method of claim 13 where said step of translating said intermediate-language code further inserts diagnostic code checking for execution-time errors into said code conforming to said second computer language.

17. A method for generating code executable by a target programmable device from code conforming to a first computer language, the method comprising:
translating said code conforming to said first computer language into intermediate language code, wherein said intermediate language conforms to Standard ECMA-335 or to a subset or a superset thereof;
translating said intermediate-language code into code conforming to a second computer language; and
translating said code conforming to said second computer language into said code directly executable by the target programmable device.

18. The method of claim 17 wherein said first computer language is selected from the group consisting of C++, including C++ with managed extensions, a version of C, an assembly language, C#, Visual Basic, Java, and Jscript.

19. The method of claim 17 wherein said second computer language is selected from the group consisting of C++, a version of C, and an assembly language.

20. A computer system for generating code executable by a target programmable device from code conforming to a first computer language, the system comprising a computer readable memory having executable code that
compiles said code conforming to said first computer language into code conforming to an intermediate language;
translates said code conforming to said intermediate-language code into code conforming to a second computer language; and
compiles said code conforming to said second computer language into said code directly executable by the target programmable device.

21. The system of claim 20 wherein said first computer language is selected from the group consisting of C++, including C++ with managed extensions, a version of C, an assembly language, C#, Visual Basic, Java, and Jscript.

22. The system of claim 20 wherein said intermediate language is selected from the group consisting of Java byte-code, p-code, a versions of Standard ECMA-335, and an assembly language, or a subset or a superset thereof.

23. The system of claim 20 wherein said second computer language is selected from the group consisting of C++, a version of C, and an assembly language.

24. The system of claim 20 wherein at least one program further causes the processor perform automatically in response to a user command the translating steps.

25. The system of claim 20 wherein at least one program further causes the processor to present information concerning the translating steps to the user in a graphical user interface format.

26. The system of claim 20 further comprising the target programmable device, and wherein at least one program further causes the processor perform a step of loading said generated, directly-executable code to the target programmable device.

27. The system of claim 26 wherein the target programmable device comprises a microprocessor, a micro-computer, or a micro-controller.

28. The system of claim 26 wherein the target programmable device comprises a control system.

29. A computer-readable medium used for generating code executable by a target programmable device from code conforming to a first computer language, the medium comprising code for causing a processor to perform the step of
translating intermediate-language code into code conforming to a second computer language,
wherein said intermediate-language code has been previously translated from said code conforming to said first computer language, and
wherein said code conforming to said second computer language is subsequently translated to said code directly executable by the target programmable device.

30. The computer-readable medium of claim 29 further comprising code for causing the processor to perform the steps of
translating said code conforming to said first computer language into said code conforming to said intermediate language; and
translating said code conforming to the second computer language into said code directly executable by the target programmable device.
